(19) United States
(12) Patent Application Publication
(10) Pub. No.: US 2024/0412039 A1
(43) Pub. Date: Dec. 12, 2024

(54) GENERATING PARALLEL SYNTHETIC TRAINING DATA FOR A MACHINE LEARNING MODEL TO PREDICT COMPLIANCE WITH RULESETS

(71) Applicant: FMR LLC, Boston, MA (US)

(72) Inventors: Vall Herard, Upper Nyack, NY (US); Santhosh Kolloju, Thirumalagiri (IN); Arindam Paul, Bangalore (IN); Sarath R. Nair, Alappuzha (IN); Pradeep Mooda, Khajaguda (IN); Chalampalem Praveen Kumar, Tirupati (IN); Sathish Kumar Chellan, Bangalore (IN); Last Feremenga, Little Elm, TX (US)

(21) Appl. No.: 18/208,470

(22) Filed: Jun. 12, 2023

(51) Int. Cl. G06N 3/0455; G06N 3/08

(52) U.S. Cl. CPC G06N 3/0455; G06N 3/08

(57) ABSTRACT

Methods and apparatuses are described for generating parallel synthetic training data for a machine learning model. A server computing device generates a model training dataset from a baseline dataset comprising a plurality of sentences labeled as noncompliant with a ruleset. The server trains a conditional autoregressive language model using the model training dataset as input to generate a corpus of synthetic predicted to be noncompliant with the rulesets. For each synthetic sentence, the server executes a compliance classification model to generate a compliance label for the synthetic sentence. The server identifies a plurality of the synthetic sentences labeled as noncompliant that are semantically similar to sentences from the baseline dataset to generate a first parallel corpus of synthetic training data. The server executes a language suggestion model using the identified synthetic sentences to generate a second parallel corpus of synthetic training data.

### TECHNICAL FIELD

This application relates generally to methods and apparatuses, including computer program products, for generating parallel synthetic training data for a machine learning model to predict compliance with one or more rulesets.

### BACKGROUND

Many organizations, particularly in industries that are highly regulated by government, have to constantly ensure compliance of communications and documents with specific rulesets and regulations imposed by such governmental entities (e.g., SEC, FINRA). Particularly for large entities, this task can be overwhelming due to the sheer volume of communications and documents that are issued to customers, brokers, vendors, and others on a daily basis. In addition, these documents may comprise multiple different digital formats and structures which makes automated review less desirable.

More recently, some organizations have attempted to use advanced machine learning text classification models and algorithms to determine whether certain documents or corpora of text are compliant with particular rulesets. However, because these documents are often domain-specific or organization-specific, the training data sets available for organizations to train their machine learning models are usually quite small and potentially sparse, containing invalid or erroneous data (e.g., incomplete sentences, grammatically incorrect sentences, data noise, etc.). This leads to inefficient model training processes and the development of weak or inaccurate classification models. Often, the training data corresponding to compliant text is much more abundant than training data corresponding to noncompliant text, resulting in an imbalanced training dataset and generating less robust classification models.

Furthermore, the use of small datasets for training models can result in overfitting and poor performance of the trained classification model. When a trained classification model has achieved a high accuracy, it generally requires much more training data to arrive at even a marginal improvement to the model. However, large amounts of quality training data may not be readily available.

### SUMMARY

Therefore, what is needed are methods and systems that can generate a large amount of synthetic training data for use in training and refining machine learning classification models, based upon only a small amount of available training data. The methods and systems described herein advantageously enable the automatic creation of parallel corpora of synthetic training data, where each corpus contains text data that is labeled as either compliant or noncompliant with one or more rulesets, using advanced generative machine learning techniques. In addition, the methods and systems described herein are capable of validating the correctness and diversity of the synthetic training data to provide for a significant increase in available training data that is suitable for any number of different downstream model training tasks.

The invention, in one aspect, features a computer system for generating parallel synthetic training data for a machine learning model. The system comprises a server computing device having a memory that stores computer-executable instructions and a processor that executes the computer-executable instructions. The server computing device generates a model training dataset from a baseline dataset comprising a plurality of sentences labeled as noncompliant with one or more rulesets. The server computing device trains a conditional autoregressive language model using the model training dataset as input to generate synthetic sentences predicted to be noncompliant with the one or more rulesets. The server computing device generates a corpus of synthetic sentences using the trained conditional autoregressive language model. For each synthetic sentence in the corpus of synthetic sentences, the server computing device executes a compliance classification model using the synthetic sentence as input to generate a label for the synthetic sentence, the label indicating whether the synthetic sentence is compliant or noncompliant with one or more rulesets. The server computing device identifies a plurality of the synthetic sentences labeled as noncompliant by the compliance classification model that are semantically similar to one or more sentences from the baseline dataset and generates a first parallel corpus of synthetic training data comprising the identified synthetic sentences. The server computing device execute a language suggestion model using the identified synthetic sentences as input to generate a second parallel corpus of synthetic training data comprising a plurality of synthetic sentences predicted to comply with the one or more rulesets.

The invention, in another aspect, features a computerized method of generating parallel synthetic training data for a machine learning model. A server computing device generates a model training dataset from a baseline dataset comprising a plurality of sentences labeled as noncompliant with one or more rulesets. The server computing device trains a conditional autoregressive language model using the model training dataset as input to generate synthetic sentences predicted to be noncompliant with the one or more rulesets. The server computing device generates a corpus of synthetic sentences using the trained conditional autoregressive language model. For each synthetic sentence in the corpus of synthetic sentences, the server computing device executes a compliance classification model using the synthetic sentence as input to generate a label for the synthetic sentence, the label indicating whether the synthetic sentence is compliant or noncompliant with one or more rulesets. The server computing device identifies a plurality of the synthetic sentences labeled as noncompliant by the compliance classification model that are semantically similar to one or more sentences from the baseline dataset and generates a first parallel corpus of synthetic training data comprising the identified synthetic sentences. The server computing device execute a language suggestion model using the identified synthetic sentences as input to generate a second parallel corpus of synthetic training data comprising a plurality of synthetic sentences predicted to comply with the one or more rulesets.

Any of the above aspects can include one or more of the following features. In some embodiments, generating the model training dataset from the baseline dataset comprises filtering out one or more sentences from the baseline dataset using a fluency scoring model. In some embodiments, the conditional autoregressive language model comprises a multi-layer transformer decoder architecture with a plurality of attention heads. In some embodiments, training the conditional autoregressive language model using the model training data set as input to generate synthetic sentences predicted to be noncompliant with the one or more rulesets comprises converting each sentence in the model training dataset into a contextual embedding, generating a plurality of probability values each corresponding to a predicted next word in the sentence based upon the contextual embedding, and determining a prediction error based upon a comparison of each predicted next word in the sentence to an actual next word in the sentence. In some embodiments, the server computing device determines the prediction error using a cross entropy loss function. In some embodiments, the server computing device backpropagates the prediction error to adjust one or more weights of the conditional autoregressive language model during training.

In some embodiments, generating a corpus of synthetic sentences using the trained conditional autoregressive language model comprises executing the trained conditional autoregressive language model using one or more configuration parameters to generate the corpus of synthetic sentences. In some embodiments, the one or more configuration parameters comprise greedy sampling, top-k sampling, top-p sampling, and temperature hyperparameters.

In some embodiments, the server computing device removes one or more duplicate sentences from the corpus of synthetic sentences before executing the compliance classification model. In some embodiments, the compliance classification model comprises a Multilingual Autoencoder that Retrieves and Generates (MARGE) model architecture. In some embodiments, identifying the plurality of the synthetic sentences labeled as noncompliant by the compliance classification model that are semantically similar to one or more sentences from the baseline dataset comprises, for each synthetic sentence: comparing the synthetic sentence to one or more sentences from the baseline dataset, determining a cosine similarity between the synthetic sentence and each of the one or more sentences from the baseline dataset, and selecting one of the one or more sentences from the baseline dataset as a semantically similar sentence based upon the cosine similarity.

In some embodiments, the language suggestion model converts one or more of the identified synthetic sentences into a corresponding synthetic sentence predicted to comply with the one or more rulesets. In some embodiments, the server computing device executes the compliance classification model on each synthetic sentence in the second parallel corpus of synthetic training data to confirm whether the synthetic sentence is compliant or noncompliant with the one or more rulesets.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating parallel synthetic training data for a machine learning model.

FIG. 2 is a flow diagram of a computerized method of generating parallel synthetic training data for a machine learning model.

FIG. 3 is a detailed block diagram of an exemplary conditional autoregressive language model used by the system.

FIG. 4 is a diagram of exemplary multi-head attention layer input generated by byte pair encoder, word embedding layer, and positional embedding layer of the model.

### DETAILED DESCRIPTION

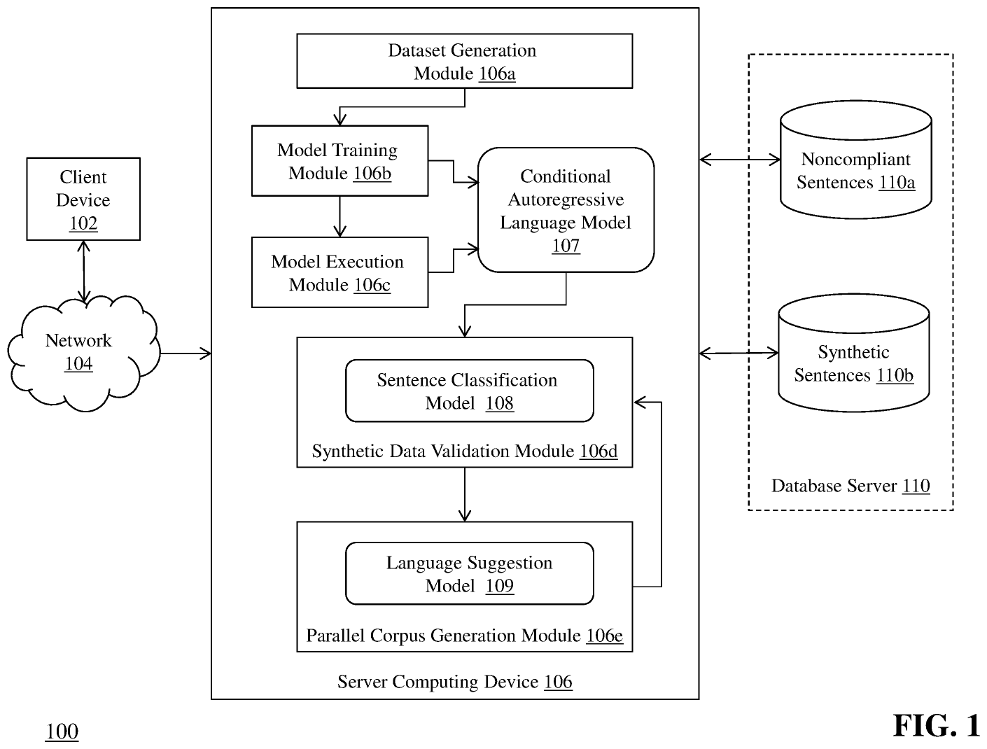

FIG. 1 is a block diagram of system 100 for generating parallel synthetic training data for a machine learning model. System 100 includes client computing device 102, communication network 104, server computing device 106 that includes dataset generation module 106a, model training module 106b, model execution module 106c, synthetic data validation module 106d, parallel corpus generation module 106e, conditional autoregressive language model 107, sentence classification model 108, and language suggestion model 109, and database server 110 comprising noncompliant sentences database 110a and synthetic sentences database 110b.

Client computing device 102 connects to communication network 104 in order to communicate with server computing device 106 to provide input and receive output relating to the process of generating parallel synthetic training data for a machine learning model as described herein. In some embodiments, client computing device 102 is coupled to an associated display device (not shown). For example, client computing device 102 can provide a graphical user interface (GUI) via the display device that is configured to receive input from a user of the device 102 and to present output (e.g., documents, reports, digital content items) to the user that results from the methods and systems described herein.

Exemplary client computing devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts a single client computing device 102, it should be appreciated that system 100 can include any number of client computing devices.

Communication network 104 enables the client computing device 102 to communicate with server computing device 106. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on a processor and interact with memory modules of server computing device 106, to receive data from other components of system 100, transmit data to other components of system 100, and perform functions for generating parallel synthetic training data for a machine learning model as described herein. As mentioned above, server computing device 106 includes dataset generation module 106a, model training module 106b, model execution module 106c, synthetic data validation module 106d, and parallel corpus generation module 106e which each execute on one or more processors of server computing device 106. Model training module 106b and model execution module 106c are coupled to conditional autoregressive language model 107. Synthetic data validation module 106d includes sentence classification model 108 and language suggestion model 109. In some embodiments, modules 106a-106e and models 107, 108, 109 are specialized sets of computer software instructions programmed onto one or more dedicated processors in the server computing device 106 and can include specifically designated memory locations and/or registers for executing the specialized computer software instructions.

Although modules 106a-106e and models 107, 108, 109 are shown in FIG. 1 as executing within the same server computing device 106, in some embodiments the functionality of modules 106a-106e and models 107, 108, 109 can be distributed among a plurality of server computing devices. As shown in FIG. 1, server computing device 106 enables modules 106a-106e and models 107, 108, 109 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 106a-106e and models 107, 108, 109 is described in detail below.

Database server 110 is a computing device (or set of computing devices) coupled to server computing device 106 and server 110 is configured to receive, generate, and store specific segments of data relating to the process of generating parallel synthetic training data for a machine learning model as described herein. Database server 110 comprises a plurality of databases, including noncompliant sentences database 110a and synthetic sentences database 110b. In some embodiments, all or a portion of the databases 110a, 110b can be integrated with server computing device 106 or be located on a separate computing device or devices. Databases 110a, 110b can comprise one or more databases configured to store portions of data used by the other components of system 100, as will be described in greater detail below.

In some embodiments, noncompliant sentences database 110a comprises structured or unstructured text corpora (or, in some embodiments, pointers to such data as stored on one or more remote computing devices) with a plurality of sentences that have been labeled as noncompliant with one or more rulesets. Typically, the text corpora relate to a particular domain (e.g., financial services, investment) for which compliance with one or more rulesets (e.g., governmental regulations) is required. An example label can be a binary value (e.g., 0 for noncompliant, 1 for compliant), an alphanumeric value (e.g., indicating the compliance result and one or more applicable rulesets), or other types of labeling mechanisms. The data in noncompliant sentences database 110a can comprise sentences that have been manually reviewed for compliance and labeled as noncompliant, either by a human reviewer or an artificial intelligence-based classification model. In some embodiments, synthetic sentences database 110b is used to store synthetic training data generated by system 100 as described herein. As can be appreciated, the synthetic training data can comprise one or more sentences generated by system 100 that are predicted to be compliant or noncompliant with one or more rulesets. As such, these synthetic sentences can be used as training data for model 107 and/or other machine learning models that may be able to utilize the training data.

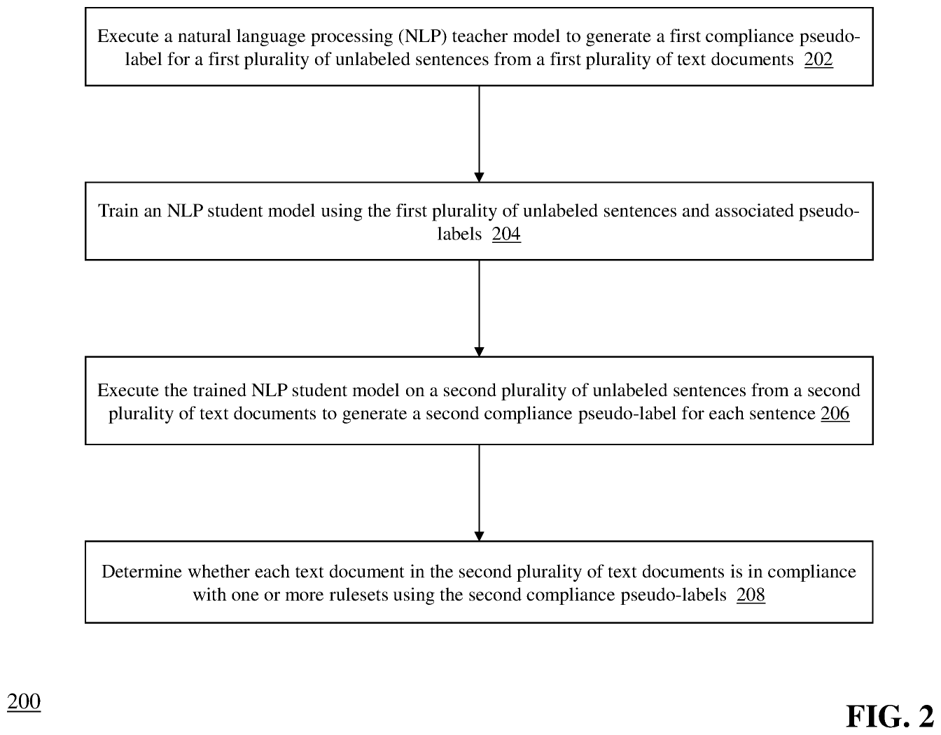

FIG. 2 is a flow diagram of a computerized method 200 of generating parallel synthetic training data for a machine learning model, using system 100 of FIG. 1. Method 200 can be understood as comprising three phases: a model training phase (to train model 107), a model execution phase (to execute model 107 to generate raw synthetic training data) and a data validation phase (to analyze the output from model 107 in order to generate synthetic parallel corpus training data). During the model training phase, module 106b trains conditional autoregressive language model 107, using labeled noncompliant sentences from database 110a as input, to be able to generate additional sentence data predicted to be noncompliant with one or more rulesets. During the model execution phase (also called the inference phase), trained conditional autoregressive language model 107 is executed by model execution module 106c to generate synthetic sentence data that is predicted by model 107 to be noncompliant with the one or more rulesets. During the data validation phase, the raw synthetic noncompliant sentence data generated from execution of model 107 is analyzed to generate (i) a corpus of validated synthetic noncompliant sentences and (ii) a parallel corpus of synthetic compliant sentences. Each of these corpuses can be used as training data for one or more machine learning models. Further details about the model training phase, the model execution phase, and the data validation phase are provided below.

### Model Training Phase

As a first step in the model training phase, dataset generation module 106a of server computing device 106 generates (step 202) a model training dataset from a baseline dataset. The baseline dataset comprises a plurality of sentences labeled as noncompliant with one or more rulesets. In some embodiments, dataset generation module 106a retrieves a plurality of sentences from noncompliant sentences database 110a for use as the model training dataset. As described previously, noncompliant sentences database 110a includes a plurality of sentences that have been labeled as noncompliant by either a human reviewer or another classification model.

In order to create a suitable model training dataset, in some embodiments dataset generation module 106a filters the noncompliant sentences retrieved from database 110a using a fluency scoring model. Generally, the fluency scoring model analyzes each sentence retrieved from database 110a and filters out sentences that have one or more deficiencies that would make them unsuitable for use as input data in training conditional autoregressive language model 107. These deficiencies can include, but are not limited to, grammatical errors, incomplete sentences, and semantic inconsistencies. The fluency scoring model can analyze each sentence and assign a fluency score to the sentence based upon the analysis. Module 106a can filter out sentences that are assigned a fluency score that falls below a predefined threshold (e.g., 0.9). Exemplary techniques for implementing the fluency scoring model are described in (i) J. H. Lau et al., “Grammaticality, Acceptability, and Probability: A Probabilistic View of Linguistic Knowledge,” Cognitive Science, Vol. 41, Issue 5, pp. 1202-1241, Oct. 12, 2016, and (ii) K. Kann et al., “Sentence-Level Fluency Evaluation: References Help, But Can Be Spared!,” arXiv:1809.08731v1 [cs.CL] 24 Sep. 2018, each of which is incorporated herein by reference.

Once the model training dataset is generated, model training module 106a trains (step 204) conditional autoregressive language model 107 using the model training dataset as input to generate synthetic sentences predicted to be noncompliant with the one or more rulesets. Generally, autoregressive language models (LMs)—such as model 107—learn to predict language using real-world contextual examples and with minimal or no explicit prior knowledge about the language structure. Autoregressive LMs do not parse words into parts of speech or apply explicit syntactic transformations. Rather, these LMs learn to encode a sequence of words into a numerical vector, called a contextual embedding, from which the LM decodes the next word. After learning, the next-word prediction principle allows the generation of well-formed, novel, context-aware sentences.

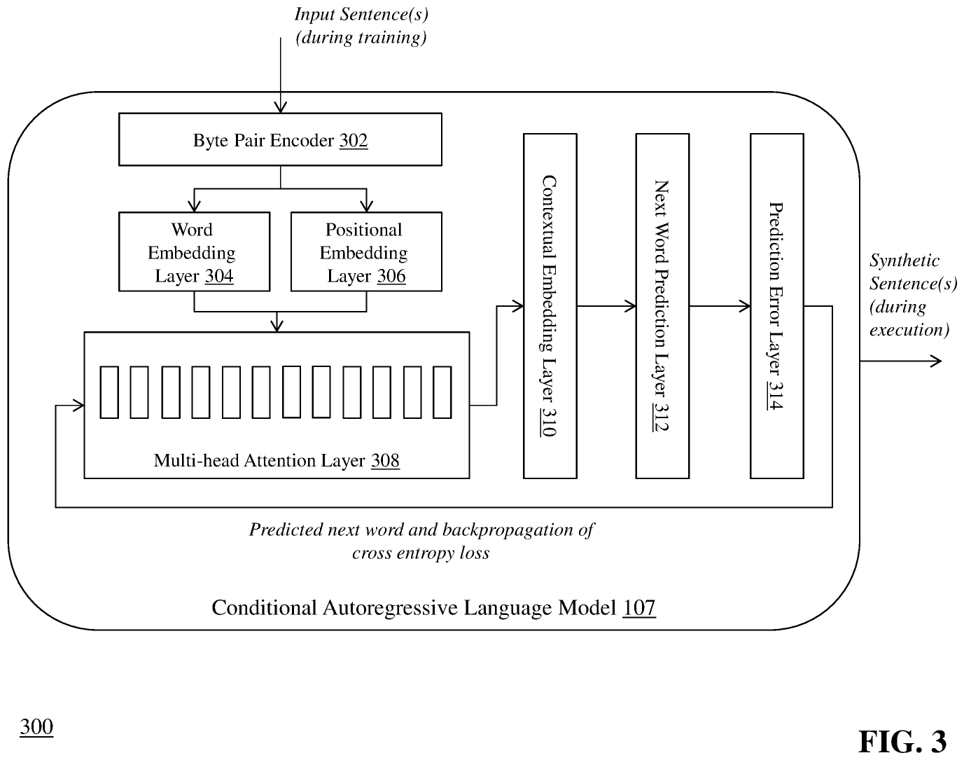

FIG. 3 is a detailed block diagram of an exemplary conditional autoregressive language model 107 of server computing device 106. As shown in FIG. 3, conditional autoregressive language model 107 is a Transformer-based decoder only architecture comprising a plurality of layers—i.e., byte pair encoder 302, word embedding layer 304, positional embedding layer 306, multi-head attention layer 308, contextual embedding layer 310, next word prediction layer 312, and prediction error layer 314. In some embodiments, model 107 is configured as a twelve-layer Transformer decoder with twelve attention heads. In an exemplary embodiment, all of the weights of model 107 are initialized with pre-trained transformer weights and then further fine-tuned on domain specific data.

Model 107 receives as input one or more sentences (e.g., noncompliant sentences from the model training dataset generated by module 106a). Byte pair encoder 302 converts each sentence into a plurality of tokens (e.g., all unique tokens form the vocabulary of the model training dataset), each token corresponding to a word and/or part of a word in the sentence. As can be appreciated, simply converting each word into a token may not account for relationships between words, such as “old,” “older,” “oldest.” Thus, the model will not be trained properly and provide erroneous results. However, if the words are split into sub-words—i.e., “older”=“old”+“er”—the model will be able to understand the relationship between these types of words. Advantageously, byte pair encoder 302 provides for sub-word tokenization of the input sentences using byte pair encoding. Traditionally, byte pair encoding involves replacing common pairs of consecutive bytes with a byte (e.g., a character value such as ‘G’) that does not appear in the data. An example of token generation performed by byte pair encoder 302 is provided below:
Input=“he is the kindest person i have known”
Output=[‘he’, ‘Ĝis’, ‘Ĝthe’, ‘Ĝkind’, ‘est’, ‘Ĝperson’, ‘Ĝi’, ‘Ĝhave,’ ‘Ĝknown’]

After the tokens are generated, word embedding layer 304 generates n-dimensional representations (e.g., vectors) for each token. Generally, a word embedding is a learned representation for text where words that have the same meaning have a similar representation. In a word embedding, individual words are represented as real-valued vectors in a predefined vector space. Each word is mapped to one vector and the vector values are learned in a way that resembles a neural network. In some embodiments, word embedding layer 304 generates a one-hot vector for each word that is based upon the overall vocabulary size. As an example, a vocabulary may comprise six words: [‘the’, ‘how’, ‘in’, ‘are’, ‘you’, ‘doing’]. Given the sentence “How are you doing?,” word embedding layer generates the following vectors for each word based upon the index of the word in the vocabulary:
‘how’→[0, 1, 0, 0, 0, 0]
‘are’→[0, 0, 0, 1, 0, 0]
‘you’→[0, 0, 0, 0, 1, 0]
‘doing’→[0, 0, 0, 0, 0, 1]

As can be appreciated, for large vocabularies, the one-hot vectors for each word have a large number of dimensions. For example, in a vocabulary of 52,000 words, a one-hot vector has 52,000 dimensions—which may be difficult or impractical to use as input to multi-head attention layer 308. In order to reduce the dimensionality of the one-hot vectors, word embedding layer 304 converts the one-hot vectors into vectors with smaller dimensionality-using the above example, a one-hot vector with 52,000 dimensions can be reduced to a vector with 768 dimensions.

Concurrently, positional embedding layer 306 generates n-dimensional representations (e.g., vectors) for each word based upon the position of the word in the input sequence. Generally, Transformer-based models-such as model 107—are configured to treat each data point as independent of the others. As such, model 107 does not account for the concept of word order in a sentence because the entire input dataset is passed into multi-head attention layer 308 in parallel. Therefore, to compensate for this, positional embedding layer 306 generates a vector encoding the position of each word in the input sequence and applies this encoding to the tokens. In one example, a positional embedding generated by layer 306 can comprise a vector with 768 dimensions.

An exemplary illustration of positional embeddings is provided below:

Consider the sentence “I love dogs and cats.” The tokens in this sentence can be represented as a sequence of integers, where each integer corresponds to a word in a vocabulary. For example, the sequence could look like [1, 2, 3, 4, 5]. Next, a matrix of positional embeddings is created for each position in the sequence. For example, the matrix could look like:
[[0.1, 0.2, 0.3],
[0.4, 0.5, 0.6],
[0.7, 0.8, 0.9],
[1.0, 1.1, 1.2],
[1.3, 1.4, 1.5]]

Finally, the positional embeddings are added to the token embeddings to obtain a final representation of each word in the sentence. For example, if the token embeddings for the words “I”, “love”, “dogs”, “and”, and “cats” are [[0.1, 0.2, 0.3], [0.4, 0.5, 0.6], [0.7, 0.8, 0.9], [1.0, 1.1, 1.2], [1.3, 1.4, 1.5]], then the final representation of each word would be:

$$\begin{matrix}[ [ 0.1 , 0.2 , 0.3 ] , \\ [ 0.4 , 0.5 , 0.6 ] , \\ [ 0.7 , 0.8 , 0.9 ] , \\ [ 1. , 1.1 , 1.2 ] , \\ [ 1.3 , 1.4 , 1.5 ] ]\end{matrix} + \begin{matrix}[ [ 0.1 , 0.2 , 0.3 ] , \\ [ 0.4 , 0.5 , 0.6 ] , \\ [ 0.7 , 0.8 , 0.9 ] , \\ [ 1. , 1.1 , 1.2 ] , \\ [ 1.3 , 1.4 , 1.5 ] ]\end{matrix} = \begin{matrix}[ [ 0.2 , 0.4 , 0.6 ] , \\ [ 0.8 , 1. , 1.2 ] , \\ [ 1.4 , 1.6 , 1.8 ] , \\ [ 2. , 2.2 , 2.4 ] , \\ [ 2.6 , 2.8 , 3. ] ]\end{matrix}$$

This final representation now includes information about the position of each word in the sequence, which can be used by model 107 to make predictions.

The word embeddings generated by layer 304 and the positional embeddings generated by layer 306 are combined to form an input dataset for multi-head attention layer 308. In an example, a given training dataset may comprise 1,024 words. As a result, an exemplary input to multi-head attention layer 308 comprises:

$$Input = WE [ 1024 \times 768 ] + PE [ 1024 \times 768 ]$$

where word embeddings (WE) (1024 vectors each having 768 dimensions) are added to positional embeddings (PE) (1024 vectors each having 768 dimensions)—which results in a vector of dimension [1024×768] which is passed as input to layer 308.

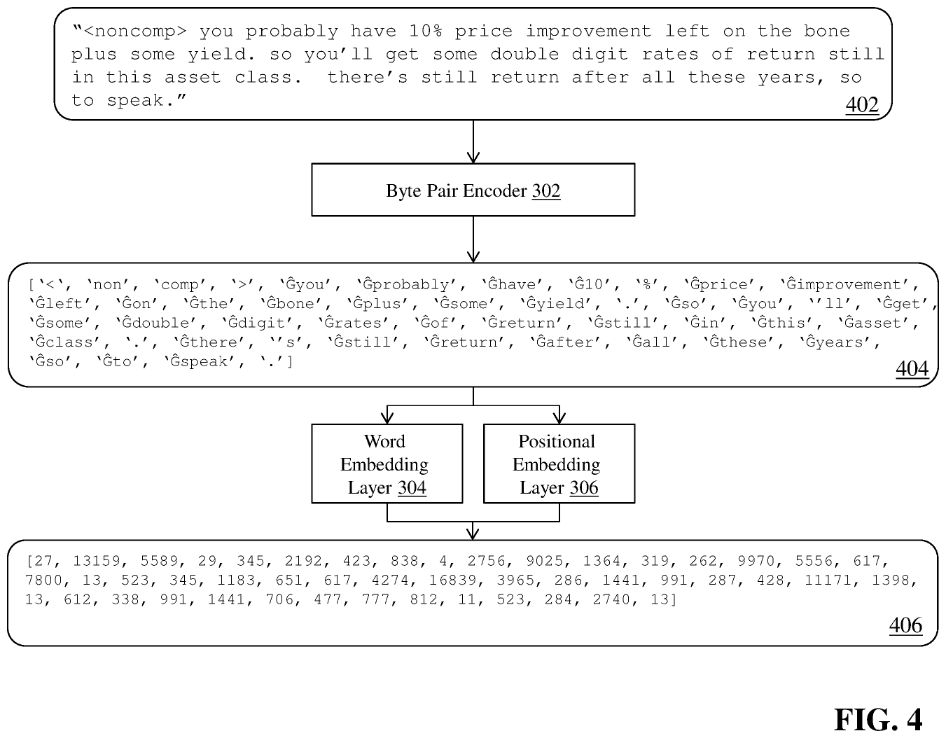

FIG. 4 is a diagram of exemplary multi-head attention layer input generated by encoder 302 and layers 304, 306. As shown in FIG. 4, the training dataset 402 comprises a text corpus with a plurality of sentences. The training dataset includes a label (‘<noncomp>’) appended to the beginning of the corpus that indicates the corpus contains noncompliant sentences. Byte-pair encoder 302 processes the text input 402 as described above to generate tokenized input 404. Word embedding layer 304 and positional embedding layer 306 each processes the tokenized input 404 as described above to generate the n-dimensional vector 406 which represents the encoded input for processing by multi-head attention layer 308.

Multi-head attention layer 308 comprises a plurality of attention heads operating on the input vector in parallel. In this context, the attention mechanism of layer 308 is closely related to visual attention as seen in humans. When humans analyze an image, we do not perceive the whole image at once, instead we see the image in parts-typically first focusing on the part of the image which helps us to understand the image better. For example, humans can focus on certain parts of the image with a high resolution while perceiving the low resolution and adjusting the focal point over time. Similar to visual attention, attention layer 308 operates to establish a relationship between different words in a sentence and/or multiple sentences.

Generally, multi-head attention is a variant of attention where multiple soft attention layers are run in parallel and their outputs are concatenated. Multi-head attention is useful because it is difficult to capture different aspects of a sentence with a single-head attention layer. For example, given the sentence “I like cats more than dogs,” it is beneficial to capture the fact that two entities are being compared while also retaining the actual entities being captured. Multi-head attention calculates multiple weighted sum vectors instead of a single attention pass over the values. Transformer models typically adopt an attention mechanism called scaled-dot product attention which can be interpreted as a way of computing the relevance of values (V) based on some keys (K) and queries (Q). The attention mechanism is a way to focus on the relevant information based on what the model is currently processing. Using a single attention head, it is difficult to capture all the concepts in a sentence. As a result, model 107 uses multiple parallel attention heads (e.g., 12 heads in model 107) with different parameters or different linear transformations to the keys, values, and queries.

Multi-head attention layer 308 receives the input vector and assigns variables Q=K=V=[1024×768]. Three parameters are learned by layer 308—Qw, Kw, Vw—which are each a matrix of dimensions [768×64]. The following matrix operations are performed by layer 308 to get a hidden representation for each word:

$$\begin{matrix}{Q}^{∧} = Q w * Q = [ 1 \; 024 \times 768 ] * [ 768 \times 64 ] = [ 1 \; 024 \times 64 ] \\ {K}^{∧} = K w * K = [ 1 \; 024 \times 768 ] * [ 768 \times 64 ] = [ 1 \; 024 \times 64 ] \\ {V}^{∧} = V w * V = [ 1 \; 024 \times 768 ] * [ 768 \times 64 ] = [ 1 \; 024 \times 64 ]\end{matrix}$$

Attention(Q,K,V)=softmax(QK^{T}/√d)V

Attention is calculated as the dot product of Q\hat{ } and K\hat{ }^{T} which is a matrix that shows the importance of each of the 1,024 words with other words:

$$Attention = ( {Q}^{∧} \cdot {K}^{∧} ) * V = [ 1 \; 024 \times 1024 ] * [ 1 \; 024 \times 64 ] = [ 1024 \times 64 ] ( matrix multiplication )$$

Then, a hidden representation of 64 dimensions for each word is generated. Each attention head of multi-head attention layer 308 performs the above operations and the output from each head is concatenated to produce a final hidden output vector of dimensions [1024×768].

Multi-head attention layer 308 provides the hidden output vector to contextual embedding layer 310. Layer 310 generates a probability distribution over the entire vocabulary—where the probability distribution comprises a probability value for each word in the vocabulary that indicates the likelihood that the word is the next word in the sequence. An exemplary contextual embedding output generated by contextual embedding layer is a vector of dimension [1024×52000], where 1,024 is the number of words in the input dataset and 52,000 is the number of words in the entire vocabulary.

Next word prediction layer 312 analyzes the contextual embedding received from layer 310 and generates a prediction of the next word in the sequence based upon the probability distribution. In one example, layer 312 selects the word associated with the maximum probability value as the predicted word. Prediction error layer 314 then calculates a cross entropy loss value for the predicted word, where the cross entropy loss increases as the predicted word diverges from the actual word. The goal in model training is to minimize the cross entropy loss. Specifically, prediction error layer 314 analyzes the cross entropy loss between the target distribution—i.e., a one-hot encoded vector of the vocabulary size (e.g., 52,000)—and the predicted distribution. An example of cross entropy loss calculation is provided below.

Example vocabulary (ten words)=[‘are,’ ‘today’, ‘how’, ‘I’, ‘think’, ‘this’, ‘that’, ‘doing’, ‘now’, ‘you’]

Training dataset passed to model 107=“how are you doing”

Therefore, the output from contextual embedding layer 310 is a vector of size [4×10], i.e., [length of training dataset×vocabulary size].

Based on the above, the target distribution for the word “how” is
[1, 0, 0, 0, 0, 0, 0, 0, 0, 0]
because the next word in the training dataset (“are”) is the first word in the vocabulary.

Contextual embedding layer 310 generates the probability distribution for “how” as follows:
[0.8, 0.1, 0.1, 0, 0, 0, 0, 0, 0, 0]
where each value in the distribution corresponds to the probability that the next word in the sequence is the corresponding word in the vocabulary. Note that the values in the distribution must always add up to 1. In this example, next word prediction layer 312 selects “are” as the predicted next word in the sequence because it has an 80% probability and provides the word “are” as input to multi-head attention layer 308 for prediction of the next word in the sequence.

Prediction error layer 314 calculates the loss for “how” as follows:

$$Loss ( ' how ' ) = ( 1 * log ( 0.8 ) + 1 * log ( 0.1 ) + 1 * log ( 0.1 ) + 0 * log ( 0 ) + 0 * log ( 0 ) + 0 * log ( 0 ) + 0 * log ( 0 ) + 0 * log ( 0 ) + 0 * log ( 0 ) + 0 * log ( 0 ) ) = 1 * log ( 0 \text{.6} ) = 0.09$$

Continuing to the next prediction, the target distribution for the word “are” (the second word in the training dataset) is:
[0, 0, 0, 0, 0, 0, 0, 0, 1]
because the next word in the training dataset (“you”) is the tenth word in the vocabulary.

Contextual embedding layer 310 generates the probability distribution for “are” as follows:
[0.1, 0.1, 0, 0, 0.6, 0, 0, 0, 0, 0.2]
which indicates that the model 107 determined probability of the next word in the sequence being “think” is 60% and the next word being “are” is 20%.

In this case, prediction error layer 314 calculates the loss for “are” as follows:

$$Loss ( ' are ' = ( 1 * log ( 0.1 ) + 1 * log ( 0.1 ) + 0 * log ( 0 ) + 0 * log ( 0 ) + 1 * log ( 0.6 ) + 0 * log ( 0 ) + 0 * log ( 0 ) + 0 * log ( 0 ) + 0 * log ( 0 ) + 1 * log ( 0.2 ) + ) = 1 * log ( 0.2 ) = 0.6$$

Therefore, as described above, the loss for the first word (“how’) is low because the model is 80% confident in its prediction of the next word as “are”. However, the loss for the second word (“are”) is high because the model is only 20% confident in its prediction of the next word as “you”. Prediction error layer 314 can calculate the overall loss for a given training data set as follows:

$$Overall loss = \frac{( loss for first word + loss for second word + … + loss for nth word )}{number of words in vocabulary}$$

Prediction error layer 314 backpropagates the overall loss for a training dataset to multi-head attention layer 308 to adjust the weights of the model to improve predictions for subsequent training.

In some embodiments, a teacher forcing technique is used during the model training phase in order to train conditional autoregressive language model 107 more efficiently.

Generally, teacher forcing enables the model 107 to discard an output prediction (e.g., the next word in the sentence) based upon calculation of an error value. For example, if the model 110 a predicts the next word in the sequence (e.g., “think”) and the actual word as seen in the training dataset (e.g., “you”) is different, prediction error layer 314 can determine an error value associated with the difference, discard the predicted word based upon the error value, and replace it with the correct word from the known output. Then, layer 314 can feed the correct word as the input into multi-head attention layer 308 for prediction of the next word, and in this way, model 107 quickly learns the correct sequence.

### Model Execution Phase (Inference Phase)

Turning back to FIG. 2, once model 107 is trained on the training dataset as described above, model execution module 106c executes trained conditional autoregressive language model 107 to generate (step 206) a corpus of synthetic sentences predicted to be noncompliant with one or more rulesets. In this context, the term ‘synthetic’ refers to the fact that the sentences generated by the trained model 107 are not extracted from pre-existing text corpora but rather are newly created by model 107 based upon the learning obtained via the training phase.

In some embodiments, model execution module 106 provides one or more seed text values (also referred to as ‘prompts’) as input to the trained conditional autoregressive language model 107 to begin generation of the synthetic sentences. In one example, model execution module 106 can use a label as the seed text value (e.g., ‘<noncomp>’) which instructs the trained model 107 to generate a corpus of synthetic sentences that are predicted to be noncompliant with one or more rulesets. In another example, model execution module 106 can use a text string comprised of one or more words (e.g., the start of a noncompliant sentence) as the seed text value and executes the trained model 107 to predict words/sentences that follow the seed text. As shown in FIG. 3, trained conditional autoregressive language model 107 generates output comprising words and sentences that are predicted as noncompliant with the one or more rulesets.

As mentioned previously, during the training phase, next word prediction layer 312 and prediction error layer 314 are configured to apply teacher forcing when selecting the predicted word, in order to quickly train the model 107. However, during the execution phase, next word prediction layer 312 and prediction error layer 314 are configured to use one or more different sampling techniques to select the predicted word when generating synthetic sentences. In some embodiments, the particular sampling technique(s) used by model 107 can be provided by model execution module 108c as configuration parameters when initiating execution of the model.

Exemplary sampling techniques that can be applied by layer 312 and layer 314 include, but are not limited to, greedy sampling, top-k sampling, and top-p sampling. Generally, greedy sampling means that next word prediction layer 312 always selects the word associated with the maximum probability value in the output distribution. For example, if the output probability distribution for the current word is [0.8, 0.1, 0.1, 0, 0, 0, 0, 0, 0, 0], the greedy sampling technique chooses the word corresponding to probability value 0.8. Generally, when performing top-k sampling, next word prediction layer 312 sorts the output probability distribution in descending order and then selects a word randomly from the top-k probability values as the next word. For example, if the output probability distribution for the current word is [0.6, 0.1, 0.2, 0, 0, 0, 0, 0.1, 0, 0] and k is 2, layer 312 sorts the distribution in descending order and selects a random word from the words corresponding to the top-2 probability values (i.e., 0.6 and 0.2). As can be appreciated, with top-k sampling, it is possible to select a predicted word that has a lower probability value than another word because the selection is random from the top-k values. Generally, when performing top-p sampling, next word prediction layer 312 sorts the output probability distribution in descending order, identifies the words whose cumulative probability is equal to or less than p, and selects a random word from the identified words. For example, if the output probability distribution for the current word is [0.7, 0.2, 0, 0, 0.1, 0, 0, 0, 0, 0], and p is 0.9, layer 312 sorts the distribution in descending order, determines that the probabilities for the top-2 words equals 0.9 (i.e., 0.7+0.2) and selects a random word from the determined words. As can be appreciated, the different types of sampling techniques can help control the randomness and originality of the synthetic sentences generated by model 107. It should be understood that the model 107 can apply one sampling technique or multiple sampling techniques when making predictions.

In addition to sampling, another configuration parameter used by model execution module 106c when executing model 107 is temperature. Generally, temperature is a hyperparameter that is used to control the randomness of predictions generated by model 107 by scaling the logits before applying the softmax function in multi-head attention layer 308. In some embodiments, the temperature can be a value between 0 and 1, where smaller values (e.g., 0.2) configure the model 107 to be more confident in its predictions but also more conservative—that is, the model becomes more deterministic and can always output the same set of tokens after a given sequence of words. Conversely, larger temperature values (e.g., 1) causes the model 107 to produce more diversity but can also lead to an increase in predicting incorrect words. Selection of a temperature value can help ensure variance and non-uniformity of the output synthetic sentences. After executing the trained conditional autoregressive language model 107, model execution module 106c stores the generated corpus of synthetic sentences in synthetic sentences database 110b.

### Data Validation Phase

Turning back to FIG. 2, synthetic data validation module 108d retrieves the synthetic sentences predicted as noncompliant from database 110b and performs a plurality of processing actions on the sentences in order to validate the suitability of the synthetic sentences for use as model training data, as described below.

For each synthetic sentence, module 106d executes sentence classification model 108 using the sentence as input to generate a label for the synthetic sentence. In this case, the label generated by model 108 indicates whether the synthetic sentence is compliant or noncompliant with one or more rulesets. In some embodiments, prior to executing sentence classification model 108, synthetic data validation module 108d can perform one or more preprocessing steps to filter out invalid or incomplete synthetic sentences. For example, module 108d can remove synthetic sentences that are syntactic duplicates of each other from the corpus (using one or more clustering methods) and leave only a single copy of the synthetic sentence in the corpus. In another example, module 108d can apply the fluency scoring model (described above) to filter out sentences that are grammatically incorrect. In yet another example module 108d can identify sentences that, e.g., lack punctuation, comprise only non-alphabetical characters, are less than a predetermined length, etc. and remove those sentences from the corpus.

The synthetic sentences that remain in the corpus generated by model 107 are then passed to sentence classification model 108 for processing. Generally, sentence classification model 108 comprises a machine learning model that is trained using, e.g., labeled noncompliant sentence data as stored in database 110a, in order generate predictions of compliance labels (i.e., compliant or noncompliant) for a given input sentence or plurality of sentences. In some embodiments, sentence classification model 108 leverages the Multilingual Autoencoder that Retrieves and Generates (MARGE) model architecture (as described in M. Lewis et al., “Pre-training via Paraphrasing,” arXiv:2006.15020v1 [cs.CL] 26 Jun. 2020, which is incorporated herein by reference) or other types of self-supervised masked language models to ensure the reliability of the sentences labeled as noncompliant. In some embodiments, MARGE is configured as a compliance scoring model designed to identify sentences in marketing documents that do not comply with FINRA Rule 2210. Given an input string, the MARGE model produces a label and a probability score indicating whether the sentence is compliant or not based on the regulatory standards. Any sentences for which model 108 cannot determine a compliance label, or to which model 108 applies a compliant label, are excluded from the corpus of synthetic sentences. The output of sentence classification model 108 is the corpus of synthetic sentences (as generated by model 107) which are labeled as noncompliant with one or more rulesets.

Using the remaining set of synthetic sentences labeled as noncompliant by model 108, synthetic data validation module 106d identifies (step 210) a plurality of the synthetic sentences that are semantically similar to one or more sentences from the baseline data set stored in database 110a. As an example, module 106d compares a sentence embedding for each synthetic sentence to a sentence embedding for each of one or more sentences from the baseline data set and determines a cosine similarity between the synthetic sentence embedding and each embedding of the one or more sentences from the baseline dataset. Exemplary techniques used by module 106d for performing the above comparison are cosine similarity using tf-idf vectors, cosine similarity using word2vec vectors, or soft cosine similarity using word2vec vectors, as described in P. Sitikhu et al., “A Comparison of Semantic Similarity Methods for Maximum Human Interpretability,” arXiv:1910.09129v2 [cs.IR] 31 Oct. 2019, which is incorporated herein by reference.

Synthetic data validation module 106d can generate a plurality of noncompliant synthetic sentence corpora using the comparison techniques described above. One corpus can be synthetic sentences that have a very high semantic similarity to sentences in the baseline dataset, while the other corpus can be synthetic sentences that are not as semantically similar to sentences in the baseline dataset—in order to promote diversity when generating the parallel corpus as set forth below. Each of these noncompliant synthetic sentence corpora can be stored in e.g., synthetic sentences database 110b as a first parallel corpus of synthetic training data for subsequent use in training one or more machine learning models.

Parallel corpus generation module 106e can use the noncompliant synthetic training corpora generated by synthetic data validation module 106d to generate a second parallel corpus of synthetic training data. Module 106e executes (step 212) language suggestion model 109 using the corpus of noncompliant synthetic training data from module 106d as input to generate a corpus of synthetic training data where the sentences are predicted to comply with the one or more rulesets. In this context, the term ‘parallel’ indicates that the first corpus of noncompliant synthetic sentences generated by module 106d and the second corpus of compliant synthetic sentences generated by module 106e can be used together as training data for a machine learning model because when combined, the corpora contribute both compliant and noncompliant sentences to the training process-resulting in a trained model that can predict and classify both compliant and noncompliant data. To generate the parallel corpus of compliant synthetic sentences, module 106e executes language suggestion model 109. In some embodiments, language suggestion model 109 is built on a proprietary foundation model that has been fine-tuned on parallel corpus of noncompliant and compliant sentences. By inputting a synthetic noncompliant sentence, language suggestion model 109 generates the equivalent compliant version. Additional information about publicly-available examples of foundation models is provided in C. Zhou et al., “A Comprehensive Survey on Pretrained Foundation Models: A History from BERT to ChatGPT,” arXiv:2302.09419v2 [cs.AI] 30 Mar. 2023, available at arxiv.org/pdf/2302.09419.pdf, which is incorporated herein by reference.

Once the compliant synthetic sentences are generated by parallel corpus generation module 108e, the sentences can be passed back to synthetic data validation module 106d, which executes sentence classification model 108 on the compliant synthetic sentences to confirm whether each synthetic sentence is predicted as compliant or noncompliant with the one or more rulesets by, e.g., applying a label to each sentence. This process is useful to validate whether the compliant synthetic sentences are labeled correctly or not. In the event that one or more compliant synthetic sentences are labeled as noncompliant by model 108, synthetic data validation module 108d can transmit these synthetic sentences to, e.g., client computing device 102 for further evaluation and re-classification by a human reviewer.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for generating parallel synthetic training data for a machine learning model, the system comprising a server computing device having a memory that stores computer-executable instructions and a processor that executes the computer-executable instructions to:
generate a model training dataset from a baseline dataset comprising a plurality of sentences labeled as noncompliant with one or more rulesets;
train a conditional autoregressive language model using the model training dataset as input to generate synthetic sentences predicted to be noncompliant with the one or more rulesets;
generate a corpus of synthetic sentences using the trained conditional autoregressive language model;
for each synthetic sentence in the corpus of synthetic sentences, execute a compliance classification model using the synthetic sentence as input to generate a label for the synthetic sentence, the label indicating whether the synthetic sentence is compliant or noncompliant with one or more rulesets;
identify a plurality of the synthetic sentences labeled as noncompliant by the compliance classification model that are semantically similar to one or more sentences from the baseline dataset and generate a first parallel corpus of synthetic training data comprising the identified synthetic sentences; and
execute a language suggestion model using the identified synthetic sentences as input to generate a second parallel corpus of synthetic training data comprising a plurality of synthetic sentences predicted to comply with the one or more rulesets.

2. The system of claim 1, wherein generating the model training dataset from the baseline dataset comprises filtering out one or more sentences from the baseline dataset using a fluency scoring model.

3. The system of claim 1, wherein the conditional autoregressive language model comprises a multi-layer transformer decoder architecture with a plurality of attention heads.

4. The system of claim 3, wherein training the conditional autoregressive language model using the model training data set as input to generate synthetic sentences predicted to be noncompliant with the one or more rulesets comprises:
converting each sentence in the model training dataset into a contextual embedding;
generating a plurality of probability values each corresponding to a predicted next word in the sentence based upon the contextual embedding; and
determining a prediction error based upon a comparison of each predicted next word in the sentence to an actual next word in the sentence.

5. The system of claim 4, wherein the server computing device determines the prediction error using a cross entropy loss function.

6. The system of claim 5, wherein the server computing device backpropagates the prediction error to adjust one or more weights of the conditional autoregressive language model during training.

7. The system of claim 1, wherein generating a corpus of synthetic sentences using the trained conditional autoregressive language model comprises executing the trained conditional autoregressive language model using one or more configuration parameters to generate the corpus of synthetic sentences.

8. The system of claim 7, wherein the one or more configuration parameters comprise greedy sampling, top-k sampling, top-p sampling, and temperature hyperparameters.

9. The system of claim 1, wherein the server computing device removes one or more duplicate sentences from the corpus of synthetic sentences before executing the compliance classification model.

10. The system of claim 1, wherein the compliance classification model comprises a Multilingual Autoencoder that Retrieves and Generates (MARGE) model architecture.

11. The system of claim 1, wherein identifying the plurality of the synthetic sentences labeled as noncompliant by the compliance classification model that are semantically similar to one or more sentences from the baseline dataset comprises, for each synthetic sentence:
comparing the synthetic sentence to one or more sentences from the baseline dataset;
determining a cosine similarity between the synthetic sentence and each of the one or more sentences from the baseline dataset; and
selecting one of the one or more sentences from the baseline dataset as a semantically similar sentence based upon the cosine similarity.

12. The system of claim 1, wherein the language suggestion model converts one or more of the identified synthetic sentences into a corresponding synthetic sentence predicted to comply with the one or more rulesets.

13. The system of claim 1, wherein the server computing device executes the compliance classification model on each synthetic sentence in the second parallel corpus of synthetic training data to confirm whether the synthetic sentence is compliant or noncompliant with the one or more rulesets.

14. A computerized method of generating parallel synthetic training data for a machine learning model, the method comprising:
generating, by a server computing device, a model training dataset from a baseline dataset comprising a plurality of sentences labeled as noncompliant with one or more rulesets;
training, by the server computing device, a conditional autoregressive language model using the model training dataset as input to generate synthetic sentences predicted to be noncompliant with the one or more rulesets;
generating, by the server computing device, a corpus of synthetic sentences using the trained conditional autoregressive language model;
for each synthetic sentence in the corpus of synthetic sentences, executing, by the server computing device, a compliance classification model using the synthetic sentence as input to generate a label for the synthetic sentence, the label indicating whether the synthetic sentence is compliant or noncompliant with one or more rulesets;
identifying, by the server computing device, a plurality of the synthetic sentences labeled as noncompliant by the compliance classification model that are semantically similar to one or more sentences from the baseline dataset and generating a first parallel corpus of synthetic training data comprising the identified synthetic sentences; and
executing, by the server computing device, a language suggestion model using the identified synthetic sentences as input to generate a second parallel corpus of synthetic training data comprising a plurality of synthetic sentences predicted to comply with the one or more rulesets.

15. The method of claim 14, wherein generating the model training dataset from the baseline dataset comprises filtering out one or more sentences from the baseline dataset using a fluency scoring model.

16. The method of claim 14, wherein the conditional autoregressive language model comprises a multi-layer transformer decoder architecture with a plurality of attention heads.

17. The method of claim 16, wherein training the conditional autoregressive language model using the model training data set as input to generate synthetic sentences predicted to be noncompliant with the one or more rulesets comprises:
converting each sentence in the model training dataset into a contextual embedding; and
generating a plurality of probability values each corresponding to a predicted next word in the sentence based upon the contextual embedding; and
determining a prediction error based upon a comparison of each predicted next word in the sentence to an actual next word in the sentence.

18. The method of claim 17, wherein the server computing device determines the prediction error using a cross entropy loss function.

19. The method of claim 18, wherein the server computing device backpropagates the prediction error to adjust one or more weights of the conditional autoregressive language model during training.

20. The method of claim 14, wherein generating a corpus of synthetic sentences using the trained conditional autoregressive language model comprises executing the trained conditional autoregressive language model using one or more configuration parameters to generate the corpus of synthetic sentences.

21. The method of claim 20, wherein the one or more configuration parameters comprise greedy sampling, top-k sampling, top-p sampling, and temperature hyperparameters.

22. The method of claim 14, wherein the server computing device removes one or more duplicate sentences from the corpus of synthetic sentences before executing the compliance classification model.

23. The method of claim 14, wherein the compliance classification model comprises a Multilingual Autoencoder that Retrieves and Generates (MARGE) model architecture.

24. The method of claim 14, wherein identifying the plurality of the synthetic sentences labeled as noncompliant by the compliance classification model that are semantically similar to one or more sentences from the baseline dataset comprises, for each synthetic sentence:
comparing the synthetic sentence to one or more sentences from the baseline dataset;
determining a cosine similarity between the synthetic sentence and each of the one or more sentences from the baseline dataset; and
selecting one of the one or more sentences from the baseline dataset as a semantically similar sentence based upon the cosine similarity.

25. The method of claim 14, wherein the language suggestion model converts one or more of the identified synthetic sentences into a corresponding synthetic sentence predicted to comply with the one or more rulesets.

26. The method of claim 14, wherein the server computing device executes the compliance classification model on each synthetic sentence in the second parallel corpus of synthetic training data to confirm whether the synthetic sentence is compliant or noncompliant with the one or more rulesets.
